(19) United States
(12) Patent Application Publication
(10) Pub. No.: US 2020/0205415 A1
(43) Pub. Date: Jul. 2, 2020

(54) COMPOSITION

(71) Applicant: Merck Patent GmbH, Darmstadt (DE)

(72) Inventors: Hiroshi OKURA, Kanagawa (JP); Stephan DERTINGER, Heidelberg (DE); Ryuta SUZUKI, Iwaki (JP); Kazuhisa AZUMA, Fukushima (JP); Ryota YAMANASHI, Ebina (JP); Eiji NISHIHARA, Tottori (JP); Tadashi ISHIGAKI, Tottori (JP); Koutoku OHMI, Tottori-shi (JP); Kenji TODA, Niigata (JP)

(73) Assignee: Merck Patent GmbH, Darmstadt (DE)

(21) Appl. No.: 16/633,691

(22) PCT Filed: Jul. 25, 2018
(86) PCT No.: PCT/EP2018/070085

§ 371 Date: Jan. 24, 2020

(30) Foreign Application Priority Data
Jul. 26, 2017 (GB) 1712006.4
Mar. 16, 2018 (EP) 18162414.9

(51) Int. Cl. A01N 59/06; C09K 11/64; C09K 11/57; C09K 11/77

(52) U.S. Cl. CPC A01N 59/06; C09K 11/7734; C09K 11/576; C09K 11/641

(57) ABSTRACT

The present invention relates to a composition comprising at least one phosphor.

### FIELD OF THE INVENTION

The present invention relates to a composition, a method manufacturing thereof, a method applying thereof to at least one portion of a plant, a method producing a plant, a method for controlling different conditions of a plant and a plant.

### BACKGROUND ART

JP 2007-135583 A mentions an organic dye having a peak wavelength at 613 nm and suggestion to use it with a thermoplastic resin as an agriculture film.

A polypropylene film containing an organic dye with peak light emission wavelength at 592 nm is disclosed in WO 1993/009664 A1.

JP H09-249773 A mentions an organic dye having peak light wavelength at 592 nm and a suggestion to use it with a polyolefin resin as an agriculture film.

A combination of an ultraviolet light emitting diode, blue, red, yellow light emitting diodes for green house light source is disclosed in JP 2001-28947 A.

JP 2004-113160 A discloses a plant growth kit with a light emitting diode light source containing blue and red light emitting diodes. (Ba,Ca,Sr)₃MgSi₂O₆:Eu²⁺,Mn²⁺ phosphor and a suggestion to use it as an agricultural lamp are described on Non Patent Literature 1.

A method applying composition including specific particulate materials to the surface of crop is described on EP 1011309B1.

### PATENT LITERATURE

1. JP 2007-135583A
2. WO 1993/009664 A1
3. JP H09-249773A
4. JP 2001-28947A
5. JP 2004-113160A
6. EP 1011309B1

### NON PATENT LITERATURE

7. “Analysis of (Ba,Ca,Sr)₃MgSi₂O₈:Eu²⁺,Mn²⁺ phosphors for application in solid state lighting”, Han et al., Journal of Luminescence (2014), vol. 148, p 1-5

### SUMMARY OF THE INVENTION

The inventors thought the wavelength by the natural light and an artificial light (e.g., a fluorescent lamp) is not optimal for growing plants, and a composition is useful which convert light and emit light with peak wavelength in the range of less than 500 nm or more than 600 nm. Depending on a plant grow stage, an optimal wavelength changes. So, the inventors thought spot and/or tentative implementation of such wavelength converting measure is useful for agriculture, without introducing specific facilities.

Some above-mentioned prior art describes light conversion sheets and optical devices for use in agriculture. But there is still a need for improved phosphors and for suitable application methods that allow for easy application and control of plant properties.

To solve those problems, the inventors conducted intensive researches and achieved a composition comprising a phosphor(s) which is useful for example, for plant photosynthesis. For those purposes, a phosphor(s) is desirable which exhibits good UV stability, good colour fastness, good colour stability, and low concentration quenching.

One aspect of this invention provides an applying method of a composition to at least one portion of a plant, preferably to the surface of a single or a plurality plant leaves. So, an embodiment of this composition which adhere to the surface of a plant is useful. For example, a composition comprising a phosphor(s) and a spreading agent(s) is useful. Applying measure of the composition is not limited to liquid state. In the case the composition is in the liquid state when applying, a phosphor(s) which exhibits good solubility and/or good suspensibility is desirable.

Inventors provided a composition comprising at least one phosphor which has a peak emission light wavelength in the range of less than 500 nm or more than 600 nm, preferably 400-500 nm or 600-730 nm. As one embodiment, the composition further comprising at least one solvent which comprises at least one selected from the group of water and organic solvent.

As one embodiment, the phosphor in the composition is at least one selected from the group consisting of an inorganic phosphor or an organic phosphor.

As one preferred embodiment, the phosphor is at least one metal oxide phosphor represented by following formula (I).

C1ₚC2_{q}C3ᵣC4ₛOₜ:MC (I)

C1 is a monovalent cation which is at least one selected from the group consisting of Li, Na, K, Rb and Cs,

C2 is a divalent cation which is at least one selected from the group consisting of Mg, Zn, Cu, Co, Ni, Fe, Ca, Sr, Ba, Mn, Ce and Sn,

C3 is a trivalent cation which is at least one selected from the group consisting of Y, Gd, Lu, Ce, La, Tb, Sc, Sm, Al, Ga, and In,

C4 is a tetravalent cation which is at least one selected from the group consisting of Si, Ti, and Ge,

MC is a metal cation which is at least one selected from the group consisting of Cr³⁺, Eu²⁺, Mn²⁺, Mn⁴, Fe³⁺, and Ce³⁺, and

p, q, r, s and t are integers on or more than 0, satisfying that (1p+2q+3r+4s)=2t, and at least one of p, q, r and s is on or more than 1.

As one embodiment, inventors found a method for manufacturing the composition comprising adding at least one phosphor into a base composition. A preferable embodiment of a base composition is a pesticide formulation and a fertilizer formulation. As one embodiment of the invention, the composition is good for implementation by applying to the surface of a plant leaves. As one embodiment of the invention, with the composition, plant can be produced and/or controlled (preferably enhanced) its photosynthesis. A container comprising the composition is also provided by the inventors. For such use, a container with cap to keep the composition inside, or a shakable style container is desirable.

In another aspect of the invention at least one phosphor is used for agriculture, preferably by applying the phosphor(s) to at least one portion of a plant, preferably to the surface of a single or a plurality of a plant leaves. The above agriculture purpose is preferably producing a plant, and/or controlling the condition of a plant, preferably its growth, ripening, appearance, colour, disease resistance or the production of plant components, sugars or other carbohydrates, vitamins or secondary metabolites (e.g. polyphenols anthocyanins). Later described phosphors can be used for this use. Compositions described below are other preferable embodiments when the phosphors applied onto the plant in said use.

The inventors surprisingly have found that there are still one or more considerable problems for which improvement are desired, as listed below; improvement of controlling property of plant condition, preferably controlling of a plant height; controlling of color of fruits; promotion and inhibition of germination; controlling of synthesis of chlorophyll and carotenoids preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites (polyphenols, anthocyanins); controlling of a disease resistance of plants; controlling of ripening of fruits, controlling of weight of plant. As one embodiment, the composition provided by inventors is good for at least one of above problem.

In another aspect, inventors provided a plant coated by at least one species of phosphor as said above. The coated phosphor preferably is located on the plant by applying the composition as said above, as one preferably embodiment. A container comprising a plant(s) is also provided by the inventors. For such use, a container suitable for refrigeration, storage or transportation (e.g., can be stacked) is preferable. As another aspect a container works as pot or vase is preferable.

### DESCRIPTION OF DRAWINGS

FIG. 1: shows black sheets covering a hydroponics system to cut natural light reaching to the system.

FIG. 2: shows a photo of Gaillardia plants of working example 5.

FIG. 3: shows the excitation and emission spectra of a phosphor synthesized as synthesis example 4.

FIG. 4: shows the excitation and emission spectra of a phosphor synthesized as synthesis example 5.

FIG. 5: shows the excitation and emission spectra of a phosphor synthesized as synthesis example 6.

FIG. 6: shows length and width of Komatsuna leaves.

FIG. 7: shows shell weights of Edamame.

FIG. 8: shows durations until flowering of Arabidopsis thaliana.

FIG. 9: shows leaves numbers of Arabidopsis thaliana.

FIG. 10: shows weights of Arabidopsis thaliana.

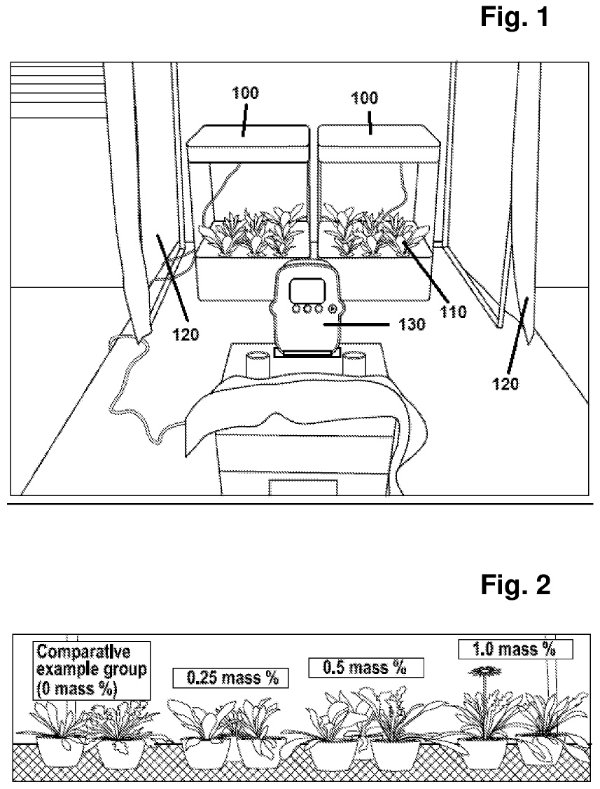

### LIST OF REFERENCE SIGNS IN FIG. 1

100. a hydroponics system UH-CB01G1 (UING Corp.)
110. a plant (Lettuce)
120. a black sheet
130. an illuminometer

### Definitions

The above outlines and the following details are for describing the present invention, and are not for limiting the claimed invention. Unless otherwise stated, the following terms used in the specification and claims shall have the following meanings for this Application.

In this application, the use of the singular includes the plural, and the words “a”, “an” and “the” mean “at least one”, unless specifically stated otherwise. In this specification, when one concept component can be exhibited by plural species, and when its amount (e.g. mass %, mol %) is described, the amount means the total amount of them, unless specifically stated otherwise.

Furthermore, the use of the term “including”, as well as other forms such as “includes” and “included”, is not limiting. Also, terms such as “element” or “component” encompass both elements or components comprising one unit and elements or components that comprise more than one unit, unless specifically stated otherwise. As used herein, the term “and/or” refers to any combination of the elements including using a single element. In the present specification, when the numerical range is shown using “to”, “-” or “˜”, the numerical range includes both numbers before and after the “to”, “-” or “˜”, and the unit is common for the both numbers, unless otherwise specified. For example, 5 to 25 mol % means 5 mol % or more and 25 mol % or less.

As used herein, “C_{x-y}”, “Cₓ-C_{y}” and “Cₓ” designate the number of carbon atoms in a molecule. For example, C₁₋₆ alkyl chain refers to an alkyl chain having a chain of between 1 and 6 carbons (e.g., methyl, ethyl, propyl, butyl, pentyl and hexyl).

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. If one or more of the incorporated literature and similar materials defines a term in a manner that contradicts the definition of that term in this application, this application controls.

The term “phosphor” in the sense of the present application is taken to mean a material which absorbs radiation in a certain wavelength range of the electromagnetic spectrum, preferably in the blue or UV spectral range, and emits visible light or far red light in another wavelength range of the electromagnetic spectrum, preferably in the violet, blue, green, yellow, orange, red spectral range or far red spectral range.

The terms “inorganic phosphor” which are used as synonyms here, denote a fluorescent inorganic material in particle form having one or more emitting centres. The emitting centres are formed by activators, usually atoms or ions of a rare-earth metal element, such as, for example, La, Ce, Pr, Nd, Pm, Sm, Eu, Gd, Tb, Dy, Ho, Er, Tm, Yb and Lu, and/or atoms or ions of a transition-metal element, such as, for example, Cr, Mn, Fe, Co, Ni, Cu, Ag, Au and Zn, and/or atoms or ions of a main-group metal element, such as, for example, Na, TI, Sn, Pb, Sb and Bi. Examples of inorganic phosphors include garnet-based phosphors, silicate-based, orthosilicate-based, thiogallate-based, sulfide-based and nitride-based phosphors. The phosphor materials can be phosphor particles with or without silicon dioxide coating. A wide variety of inorganic phosphors come into consideration for the present invention, such as, for example, metal-oxide phosphors, silicate and halosilicate phosphors, phosphate and halophosphate phosphors, borate and borosilicate phosphors, aluminate, gallate and alumosilicate phosphors, phosphors, sulfate, sulfide, selenide and telluride phosphors, nitride and oxynitride phosphors and SiAlON phosphors. In a preferred embodiment of the present invention, the inorganic phosphor is selected from metal oxides, silicates and halosilicates, phosphates and halophosphates, borates and borosilicates, aluminates, gallates and alumosilicates, molybdates and tungstates, sulfates, sulfides, selenides and tellurides, nitrides and oxynitrides, SiAlONs, halides and oxy compounds, such as preferably oxysulfides or oxychlorides. Preferred metal-oxide phosphors are arsenates, germanates, halogermanates, indates, lanthanates, niobates, scandates, stannates, tantalates, titanates, vanadates, halovanadates, phosphovanadates, yttrates, zirconates, molybdate and tungstate. The term “emission” means the emission of electromagnetic waves by electron transitions in atoms and molecules.

The term “radiation-induced emission efficiency” should also be understood in this connection, i.e. the phosphor absorbs radiation in a certain wavelength range and emits radiation in another wavelength range with a certain efficiency.

The term “shift of the emission wavelength” is taken to mean that a phosphor emits light at a different wavelength compared with another, i.e. shifted towards a shorter or longer wavelength.

### DETAILED DESCRIPTION OF THE INVENTION

According to the present invention, a composition comprising at least one phosphor which has a peak emission light wavelength in the range of less than 500 nm or more than 600 nm (preferably 250-500 nm or 600-1,500 nm, very preferably 300-500 nm or 600-1,000 nm, particularly preferably 350-500 nm or 600-800 nm, more preferably 400-500 nm or 600-750 nm, further preferably 400-500 nm or 600-730 nm, furthermore preferably 430-500 nm or 600-730 nm) is provided. For an explanation purpose but not intent to limit any scope of the invention, all of (i) a phosphor having a peak emission light wavelength at 380 nm, (ii) a phosphor having a peak emission light wavelength at 1 μm, and (iii) a phosphor having a peak emission light wavelength at 380 nm and 1 μm, fall within the scope of the phosphor comprised in the composition.

Phosphors

According to the present invention, any type of phosphors having a peak emission light wavelength in the range of less than 500 nm or more than 600 nm (preferably 250-500 nm or 600-1,500 nm, very preferably 300-500 nm or 600-1,000 nm, particularly preferably 350-500 nm or 600-800 nm, more preferably 400-500 nm or 600-750 nm, further preferably 400-500 nm or 600-730 nm, further more preferably 430-500 nm or 600-730 nm), for example as described in the second chapter of Phosphor handbook (Yen, Shinoya, Yamamoto), can be used as desired. As to a peak emission light wavelength in the range of less than 500 nm said above, it is one another embodiment that the wavelength 650-750 nm is preferable (655-740 nm is more preferable, 660-710 nm is furthermore preferable). As to a peak emission light wavelength in the range of more than 600 nm said above, it is one another embodiment that the wavelength 420-480 nm is preferable (430-460 nm is more preferable).

As one embodiment of the invention, a phosphor or its denatured (e.g., degraded) substance which less harms animals, plants and/or environment (e.g., soil, water) is desirable. Thus, one embodiment of the invention, the phosphor is non-toxic phosphors, preferably it is edible phosphors.

Plural types of phosphors can be used in one composition. For example, (i) a phosphor having a peak emission wavelength at 450 nm and (ii) a phosphor having a peak emission light wavelength at 700 nm can be used in one composition. In another aspect, a phosphor having a peak emission light wavelength in the range of 500-600 nm can be used in one composition as a co-phosphor with a main phosphor having a peak emission light wavelength in the range of less than 500 nm or more than 600 nm. As such co-phosphor, it is preferable the emitted light from co-phosphor can be used as excitation light (absorption light) for a main phosphor. As one another embodiment of this invention, a phosphor having a plurality of emission light wavelengths is also preferable for the composition.

As one embodiment of the invention, it is preferable that a phosphor comprises a first phosphor, a second phosphor and/or a third phosphor,

the first phosphor has at least a first peak wavelength of light emitted from the phosphor in the range of 600-750 nm (preferably 650-720 nm, more preferably 660-710 nm),

the second phosphor has at least a first peak wavelength of light emitted from the phosphor in the range of 400-500 nm (preferably 400-490 nm, more preferably 430-480 nm), and

the third phosphor has a first peak wavelength of light emitted from the phosphor in the range of 600-750 nm and a second peak wavelength of light emitted from the phosphor of 400-500 nm (preferably the first peak wavelength 650-720 nm and the second peak wavelength 400-490 nm, more preferably the first peak wavelength 660-710 nm and the second peak wavelength 430-480 nm).

According to the present invention, the term peak wavelength comprises both the main peak of an emission/absorption (preferably emission) spectrum having maximum intensity/absorption and side peaks having smaller intensity/absorption than the main peak. Preferably, the term peak wavelength is related to a side peak. Preferably, the term peak wavelength is related to the main peak having maximum intensity/absorption.

Those phosphors can be inorganic phosphors and/or organic phosphors.

As another embodiment, the phosphors are preferable for plant growth, which has an absorption peak wavelength in UV and/or green light (420, 560 nm), and an emission peak wavelength in near infrared ray region (650-730 nm, more preferably from 650-700 nm). The phosphors are preferable which have a narrow full width at half maximum (hereafter “FWHM”) of the light emission.

Inorganic Phosphors

Inorganic phosphors of this invention can be selected from the group consisting of metal oxides, silicates, halosilicates, phosphates, halophosphates, borates, borosilicates, aluminates, gallates, alumosilicates, molybdates, tungstates, sulfates, sulfides, selenides, tellurides, nitrides, oxynitrides, SiAlONs, halides and oxy compounds (preferably oxysulfides or oxychlorides). As another aspect of this invention, inorganic phosphors of this invention can be more preferably selected from the group consisting of sulfides, thiogallates, nitrides, oxy-nitrides, silicates, metal oxides, apatites, phosphates, selenides, borates, carbon materials, quantum sized materials and a combination thereof (more preferably sulfides, thiogallates, nitrides, oxy-nitrides, silicates, metal oxides, apatites, phosphates, selenides, borates and carbon materials). One preferred embodiment of the silicate is a fluorescent mica and/or a fluorescent pearl pigment.

The inorganic phosphors can be at least one metal oxide phosphor represented by following formula (I).

C1ₚC2_{q}C3ᵣC4ₛOₜ:MC (I)

C1 is a monovalent cation which is at least one selected from the group consisting of Li, Na, K, Rb and Cs. As one phosphor represented by formula (I), plural species of C1 can be selected. C1 selected from Li and/or Na is preferable.

C2 is a divalent cation which is at least one selected from the group consisting of Mg, Zn, Cu, Co, Ni, Fe, Ca, Sr, Ba, Mn, Ce and Sn. As one phosphor represented by formula (I), plural species of C2 can be selected.

C2 selected from Mg, Zn, Ca, Sr, Ba, and/or Sn is preferable, selected from Mg, Zn, Ca, Sr, and/or Ba is more preferable.

C3 is a trivalent cation which is at least one selected from the group consisting of Y, Gd, Lu, Ce, La, Tb, Sc, Sm, Al, Ga, and In. As one phosphor represented by formula (I), plural species of C3 can be selected.

C3 selected from Y, Gd, Al, and/or Ga is preferable, selected from Al is more preferable.

C4 is a tetravalent cation which is at least one selected from the group consisting of Si, Ti, and Ge. As one phosphor represented by formula (I), plural species of C4 can be selected. C4 selected from Si, and/or Ti is preferable, selected from Ti is more preferable.

MC is a metal cation which is at least one selected from the group consisting of Cr³⁺, Eu²⁺, Mn²⁺, Mn⁴⁺, Fe³⁺, and Ce³⁺. As one phosphor represented by formula (I), plural species of MC can be selected. MC selected from Cr³⁺, Eu²⁺, Mn²⁺ and/or Mn⁴⁺ is preferable. MC selected from Cr³⁺, “Eu²⁺, Mn²⁺”, Mn²⁺, and Mn⁴⁺ is more preferable. In the case plural MC selected, selecting same valent number cations is one preferable embodiment.

p, q, r, s and t are integers on or more than 0, satisfying that (1p+2q+3r+4s)=2t. At least one of p, q, r and s is on or more than 1. It is one preferable embodiment that p, q, r, and s are each independently 0-6, more preferably 0-5, further preferably 0-3, furthermore preferably 0-2. It is preferable embodiment that t is 1-20, more preferably 1-9, further preferably 2-8, furthermore preferably 2-5. MC can be replaced with same valent number cation. In the case MC is Eu²⁺ and/or Mn²⁺, q is on or more than 1 is preferable. In the case MC is Cr³⁺ Fe³⁺ and/or Ce³⁺, r is on or more than 1 is preferable. In the case MC is Mn⁴, s is on or more than 1 is preferable.

As further preferred embodiment, the inorganic phosphor can be a Cr activated metal oxide phosphor, and/or a Mn activated metal oxide phosphor.

One embodiment of the Cr activated metal oxide phosphor is represented by following formula (II).

AₓB_{y}O_{z}:Cr³⁺ (II)

A is a trivalent cation and is selected from the group consisting of Y, Gd, Lu, Ce, La, Tb, Sc, and Sm. Preferably A is selected from Y and Gd.

B is a trivalent cation and is selected from the group consisting of Al, Ga, Lu, Sc, and In. Preferably B is selected from Al and Ga.

x and y are integers. x≥0, y≥1, and 1.5(x+y)=z. Preferably x is 0-5, and y is 1-8. More preferably x is 0-3, and y is 1-5.

Another embodiment of the Cr activated metal oxide phosphor is represented by following formula (III).

XₐZ_{b}O_{c}:Cr³⁺ (III)

X is a divalent cation and is selected from the group consisting of Mg, Zn, Cu, Co, Ni, Fe, Ca, Sr, Ba, Mn, Ce and Sn. Preferably X is selected from Mg, Co, and Mn.

Z is a trivalent cation and is selected from the group consisting of Al, Ga, Lu, Sc and In. Preferably Z is selected from Al and Ga.

a and b are integers. b≥0, a≥1, and (a+1.5b)=c. Preferably a is 1-3, and b is 0-6. More preferably a is 1-2, and b is 0-4.

One embodiment of the Mn activated metal oxide phosphor is represented by following formula (IV).

C2_{q}C3ᵣC4₈Oₜ:MC²⁺ (IV)

MC²⁺ is a divalent metal cation selected from “Eu^{2+”,} “Mn²⁺”, or “Eu²⁺, Mn²⁺”. Preferably MC²⁺ is selected from “Mn²⁺”, or “Eu²⁺, Mn²⁺”.

Definitions of C2, C3, C4, q, r, s and t are each independently same to above describing about formula (I). Embodiments of C2, C3, C4, q, r, s and t are each independently same to above describing about formula (I). As to a phosphor represented by formula (IV), it is preferable that q=1-5, r=0-4, s=0-3, and t=3-9, and more preferable that q=1-4, r=0-3, s=0-2, and t=4-8.

Another embodiment of the Mn activated metal oxide phosphor is represented by following formula (V).

C2_{q}C3ᵣC4Oₜ:Mn⁴⁺ (V)

Definitions of C2, C3, C4, q, r, s and t are each independently same to above describing about formula (I). Embodiments of C2, C3, C4, q, r, s and t are each independently same to above describing about formula (I). As to a phosphor represented by formula (V), it is preferable that q=0-9, r=0-15, s=0-8, and t=3-20, and more preferably that q=1-7, r=0-12, s=0-6, and t=4-19.

As another preferred embodiment of the present invention, the inorganic phosphor is selected from one or more of metal oxide phosphors represented by following formulae (I′) to (X′) and (VII″).

AₓB_{y}O_{z}:Mn⁴⁺ (I′)

wherein A is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4, more preferably, formula (I′) is Mg₂TiO₄:Mn⁴⁺.

XₐZ_{b}O_{c}:Mn⁴⁺ (II′)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3, more preferably formula (II′) is Li₂TiO₃:Mn⁴⁺.

D_{d}EₑOᵣ:Mn⁴⁺ (III′)

wherein D is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc³⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19, more preferably formula (III′) is CaAl₁₂O₁₉:Mn⁴⁺.

D_{g}EₕOᵢ:Mn⁴⁺ (IV′)

wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5g+1.5h)=l, preferably D is La³⁺, E is Al³⁺, Gd³⁺ or a combination of these, g is 1, h is 12, i is 19, more preferably formula (IV′) is LaAlO₃:Mn⁴⁺.

GⱼJₖLₗOₘ:Mn⁴⁺ (V′)

wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.5l)=m, preferably G is selected from Ca²⁺, Sr²⁺, Ba²⁺ or a combination of any of these, J is Y³⁺, Lu³⁺ or a combination of these, L is Al³⁺, Gd³⁺ or a combination of these, j is 1, k is 1, l is 1, m is 4, more preferably it is CaYAlO₄:Mn⁴⁺.

MₙQₒRₚO_{q}:Eu,Mn (VI′)

wherein M and Q are divalent cations and are, independently or dependently of each other, selected from one or more members of the group consisting of Mg²⁺, Zn²⁺, Cu²⁺, CO²⁺, Ni²⁺, Fe²⁺, Ca²⁺, Sr²⁺, Ba²⁺, Mn²⁺, Ce² and Sn²⁺; R is Ge³⁺, Si³⁺, or a combination of these; n≥1; o≥0; p≥1; (n+o+2.0p)=q, preferably M is Ca²⁺, Sr²⁺, Ba²⁺ or a combination of any of these, Q is Mg²⁺, Ca²⁺, Sr²⁺, Ba²⁺, Zn²⁺ or a combination of any of these, R is Ge⁺, Si³⁺, or a combination of these, n is 1, o is 1, p is 2, q is 6, more preferably it is CaMgSi₂O₆:Eu²⁺, Mn²⁺.

A₅P₆O₂₅:Mn⁴⁺ (VII′)

wherein the component “A” stands for at least one cation selected from the group consisting of Si⁴⁺, Ge⁴⁺, Sn⁴⁺, Ti⁴⁺ and Zr⁴⁺.

(A₁₋ₓMnₓ)₅P₆O₂₅ (VII″)

The component A stands for at least one cation selected from the group consisting of Si⁴⁺, Ge⁴⁺, Sn⁴⁺, Ti⁴⁺ and Zr⁴⁺, preferably A is Si⁴⁺; 0<x≤0.5, preferably 0.05<x≤0.4, preferably Mn of formula (VII″) is Mn⁴⁺.

XO₆ (VIII′)

wherein X=(A¹)₂B¹(C¹₍₁₋ₓ₎Mn⁴⁺_{5/4x}), or X=A²B²C²(D¹_{(1-y)}Mn⁴⁺_{1.5y}), 0<x≤0.5, 0<y≤0.5.

A¹, B¹, C¹, A², B², C² and D¹ are defined and described in below.

A¹₂B¹C¹O₆:Mn⁴⁺ (IX′)
A¹=at least one cation selected from the group consisting of Mg²⁺, Ca²⁺, Sr²⁺ and Ba²⁺ Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;

preferably the phosphor represented by chemical formula (IX′) Ba₂YTaO₆:Mn⁴⁺.

A²B²C²D¹O₆:Mn⁴⁺ (X′)
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺, and

preferably the phosphor represented by chemical formula (X′) is NaLaMgWO₆:Mn⁴⁺.

A Mn activated metal oxide phosphor represented chemical formula (VI′) is more preferable since it emits a light with a first peak wavelength in the range from 400-500 nm and a second peak wavelength in the range from 600-750 nm, preferably the Mn activated metal oxide phosphor represented chemical formula (VI′) emits light with the first peak wavelength in the range from 430-490 nm, and the second peak wavelength in the range from 650-720 nm, more preferably the first peak wavelength of light emitted from the inorganic phosphor is 450 nm and the second peak wavelength of light emitted from the inorganic phosphor is in the range from 660-710 nm.

As a preferred embodiment of the present invention, the inorganic phosphor can be selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₁₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Mg₈Ge₂O₁₁F₂:Mn⁴⁺, CaGa₂S₄:Mn²⁺, Gd₃Ga₅O₁₂:Cr³⁺, Gd₃Ga₅O₁₂:Cr³⁺,Ce³⁺, (Ca,Ba,Sr) MgSi₂O₆:Eu,Mn, (Ca,Ba,Sr)₂MgSi₂O₇:Eu,Mn, (Ca,Ba,Sr)₃MgSi₂O₈:Eu,Mn, ZnS, InP/ZnS, CuInS₂, CuInSe₂, CuInS₂/ZnS, carbon quantum dot, CaMgSi₂O₆:Eu²⁺, Mn²⁺, Si₅P₆O₂₅:Mn⁴⁺, Ba₂YTaO₆:Mn⁴⁺, NaLaMgWO₆:Mn⁴⁺, Y₂MgTiO₆:Mn⁴⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu²⁺, NaSrPO₄:Eu²⁺, KBaPO₄:Eu²⁺, KSrPO₄:Eu²⁺, KMgPO₄:Eu²⁺, □-Sr₂P₂O₇:Eu²⁺, □-Ca₂P₂O₇:Eu²⁺, Mg₃(PO₄)₂:Eu²⁺, Mg₃Ca₃(PO₄)₄:Eu²⁺, BaMgAl₁₀O₁₇:Eu²⁺, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, CaAlSiN₃:Eu²⁺, SrAlSiN₃:Eu²⁺, Sr₂Si₅Na:Eu²⁺, SrLiAlN₄:Eu²⁺, LiAl₅O₈:Cr³⁺, SrAlSi₄N₇:Eu²⁺, Ca₂SiO₄:Eu²⁺, NaMgPO₄:Eu²⁺, CaS:Eu²⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn⁴⁺, YVO₄:Eu³⁺, MgSr₃Si₂O₈:Eu²⁺,Mn²⁺, Y₂O₃:Eu³⁺, Ca₂Al₃O₆FGd₃Ga₅O₁₂:Cr³⁺,Ce³⁺ and graphene quantum dot, and combination thereof. Any combination of any of these can be selected as a phosphor for the invention.

As one more preferred embodiment, the inorganic phosphor is selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Gd₃Ga₅O₁₂:Cr³⁺, Gd₃Ga₅O₁₂:Cr³⁺,Ce³⁺, (Ca,Ba,Sr)MgSi₂O:Eu²⁺,Mn²⁺, (Ca,Ba,Sr)₂MgSi₂O:Eu²⁺,Mn²⁺, (Ca,Ba,Sr)₃MgSi₂O₈:Eu²⁺, Mn²⁺, ZnS, InP/ZnS, CuInS₂, CuInSe₂, CuInS₂/ZnS, carbon quantum dot, and combination thereof. For example, “Eu²⁺, Mn²⁺” in one embodiment “MgSr₃Si₂O₈:Eu²⁺, Mn²⁺” means both Eu²⁺ and Mn²⁺ works as co-activations of a metal oxide phosphor of the invention. “(Ca, Ba, Sr)” in one embodiment “(Ca, Ba, Sr)MgSi₂O₆:Eu²⁺,Mn²⁺” means that Ca, Ba and Sr can be replaced each other to work as this phosphor.

A quantum dot material can be used as an inorganic phosphor. Preferable embodiments of it is ZnS, InP/ZnS, CuInS₂, CuInSe₂, CuInS₂/ZnS and/or carbon quantum dot. One preferred embodiment of this carbon quantum dot is a graphene quantum dot.

More preferred embodiments of present inorganic phosphor can be selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Mg₂TiO₄:Mn⁴⁺, Li₂TiO₃:Mn⁴⁺, CaAl₁₂O₁₉:Mn⁴⁺, Mg₂TiO₄:Mn⁴⁺, CaMgSi₂O₆:Eu²⁺, Mn₂, Si₅P₆O₂:Mn⁴⁺, Ba₂YTaO₆:Mn⁴⁺, NaLaMgWO₆:Mn⁴⁺ and combination thereof (further more preferably Al₂O₃:Cr³⁺, Y₃Al₅O₁₂:Cr³⁺, MgO:Cr³⁺, ZnGa₂O₄:Cr³⁺, MgAl₂O₄:Cr³⁺, Mg₂TiO₄:Mn⁴⁺, Li₂TiO₃:Mn⁴⁺, CaAl₁₂O₁₉:Mn⁴⁺ and combination thereof). Those metal oxides can function as micronutrients and/or fertilizer.

Organic Phosphor

Organic phosphors of this invention can be selected from the group consisting of fluoresceines, rhodamines, coumarines, pyrenes, cyanines, perylenes, and di-cyano-methylenes, and combination thereof. Organic compounds which exhibit photo-luminesce can be used for this invention purpose. For example, in the OLED field such compounds are known as an emitter or a dopant. A fluorescent emitter in OLED can be more preferable for this invention purpose.

Composition

Our invention provides a composition comprising the phosphor. It is preferable embodiment that the composition is an agriculture composition, as the composition can be used for agriculture (more preferably for applying to at least one portion of a plant). In this invention and specification, an intermediate and an intermediate state (e.g. an intermediate of a polymer sheet, the polymer sheet is a final product) are excluded in a preferred embodiment of the present invention from the meaning of the composition. For applying to at least one portion of a plant (preferably to the leave surface), it is preferable that the composition comprises less solidifying component (e.g. polymer, resin and/or crosslinking agent). As one embodiment, the mass ratio of the solidifying component to the total mass of the composition is 0-0.5 mass %, preferably 0-0.1 mass %, and more preferably 0-0.01 mass %. A composition comprises no solidifying component (0 mass %) is one preferable embodiment.

Here, above polymer and resin preferably has a weight average molecular weight in the range 5,000-50,000, more specifically 10,000-30,000. The molecular weight Mw of polymer and resin can be determined by means of GPC(=gel permeation chromatography) against an internal polystyrene standard.

Matrix Material

As one embodiment of the invention, the composition can comprise single or a plurality of matrix materials suitable for agriculture. As the matrix material, an oligomer or a polymer material, preferably an organic oligomer or an organic polymer material, more preferably an organic polymer selected from the group consisting of a transparent photosetting polymer, a thermosetting polymer, a thermoplastic polymer, or a combination of any of these, can be used preferably. As organic polymer materials, polyethylene, polypropylene, polystyrene, polymethyl pentene, polybutene, butadiene styrene, polyvinyl chloride, polystyrene, polymethacrylic styrene, styrene-acrylonitrile, acrylonitrile-butadiene-styrene, polyethylene terephthalate, polymethyl methacrylate, polyphenylene ether, polyacrylonitrile, polyvinyl alcohol, acrylonitrile polycarbonate, polyvinylidene chloride, polycarbonate, polyamide, polyacetal, polybutylene terephthalate, polytetrafluoroethylene, phenol, melamine, urea, urethane, epoxy, unsaturated polyester, polyallyl sulfone, polyacrylate, hydroxybenzoic acid polyester, polyetherimide, polycyclohexylenedimethylene terephthalate, polyethylene naphthalate, polyester carbonate, polylactic acid, phenolic resin, silicone or a combination of any of these can be used preferably. As the matrix material, a glass material, preferably a soda-lime glass material, a borosilicate glass material and a quartz glass material can be used. As one another preferable embodiment, one or plurality of additives described below can be used as the matrix material.

Additive

The composition according to the present invention can further comprise additives. Comprising a spreading agent and/or a surface treatment agent is one preferable embodiment.

When the composition applied onto the leaves, the composition had better to remain on the leaves for some period to exhibit its property. But wax secreted by leaves can inhibit this composition remained on leaves, and drop off it from the leaves. A spreading agent functions improving spreading performances, wettability, and/or adhesion of the composition. A surface treatment agent can change the polarity of the phosphor or leave surface (preferably the phosphor) to decrease repulsive force between them. Preferably a spreading agent can be selected from the group consisting of isopropyl myristate, isopropyl palmitate, caprylic/capric acid esters of saturated C12-18 fatty alcohols, oleic acid, oleyl ester, ethyl oleate, triglycerides, silicone oils, dipropylene glycol methyl ether, and combination thereof. One preferred embodiment of a spreading agent is Approach BI (Trade mark, Kao Corp.).

As one embodiment, the mass ratio of the spreading agent to the mass of the phosphor in the composition is 5-200 mass %, preferably 5-100 mass %, more preferably 5-20 mass %, and furthermore preferably 7.5-15 mass %. As one embodiment, the mass ratio of the surface treatment agent to the mass of the phosphor in the composition is 5-200 mass %, preferably 5-100 mass %, more preferably 5-20 mass %, and furthermore preferably 7.5-15 mass %.

The composition can further comprise an ingredient(s). Preferable embodiments of the ingredient are an adjuvant, a dispersant, a surfactant, a fungicide, a pesticide, a fertilizer, an antimicrobial agent, and/or an antifungal agent. An adjuvant can enhance permeability of effective component (e.g. insecticide), inhibit precipitation of solute in the composition, or decrease a phytotoxicity. The solutes (e.g. the phosphors) in the composition are not necessarily dissolved in the composition. In the case the composition is liquid, a dispersant is useful because it helps the solutes to be applied uniformly to at least one portion of a plant (preferably to the surface of the plant leaves). In here, a surfactant means it does not comprise or is not comprised by other additives, for example a spreading agent, a surface treatment agent and an adjuvant. In the case the composition is liquid, a phosphor with good suspensibility is desirable because the phosphor is easily suspended in the composition.

Preferably an adjuvant can be selected from the group consisting of a mineral oil, an oil of vegetable or animal origin, alkyl esters of such oils or mixtures of such oils and oil derivatives, and combination thereof. Preferred embodiments of the surfactant are polyoxyethylene alkyl ethers (e.g., polyoxyethylene lauryl ether, polyoxyethylene oleyl ether and polyoxyethylene cetyl ether); polyoxyethylene fatty acid diethers; polyoxyethylene fatty acid monoethers; polyoxyethylene-polyoxypropylene block polymer; acetylene alcohol; acetylene glycol derivatives (e.g., acetylene glycol, polyethoxyate of acetylene alcohol, and polyethoxyate of acetylene glycol); silicon-containing surfactants (e.g., Fluorad (Trademark, Sumitomo 3M Ltd), MEGAFAC (Trademark, DIC Corp.), and Surufuron (Trademark, Asahi Glass Co., Ltd.)); and organic siloxane surfactants, such as, KP341 (Trademark, Shin-Etsu Chemical Co., Ltd.).

Examples of the above acetylene glycols include: 3-methyl-1-butyne-3-ol, 3-methyl-1-pentyne-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-hexyne-2,5-diol, and 2,5-dimethyl-2,5-hexanediol.

Examples of anionic surfactants include: ammonium salts and organic amine salts of alkyldiphenylether disulfonic acids, ammonium salts and organic amine salts of alkyldiphenylether sulfonic acids, ammonium salts and organic amine salts of alkylbenzenesulfonic acids, ammonium salts and organic amine salts of polyoxyethylenealkylether sulfuric acids, and ammonium salts and organic amine salts of alkyl-sulfuric acids. Further, examples of the amphoteric surfactants include 2-alkyl-N-carboxymethyl-N-hydroxyethyl imidazolium betaine, and laurylic acid amidopropyl hydroxy sulfone betaine.

Explanations of a pesticide and a fertilizer are described in later. Here, an active ingredient of pesticide formulation is a pesticide ingredient. And here, an active ingredient of fertilizer formulation is a fertilizer ingredient.

As one embodiment, the mass ratio of each 1 additive of dispersant, surfactant, fungicide, a pesticide, a fertilizer, antimicrobial agent and antifungal agent, to the mass of the phosphor in the composition is 5-200 mass %, preferably 5-200 mass %, more preferably 5-150 mass %, further preferably 5-20 mass %, and furthermore preferably 7.5-15 mass %.

Solvent

The composition can further comprise at least one solvent which comprises at least one selected from the group of water and organic solvent. Known usual water can be used as said water, which can be selected from agricultural water, tap-water, industrial water, pure water, distilled water and deionized water. Including said organic solvent in the composition is useful for dissolving the solute. The organic solvent is preferably selected from alcohol solvent, ether solvent and mixture thereof. One preferable embodiment of said alcohol solvent is selected from ethanol, isopropanol, cyclohexanol, phenoxyethanol, benzyl alcohol or mixture thereof. More preferable embodiment of said alcohol solvent is ethanol. One preferable embodiment of said ether solvent is selected from dimethyl ether, propyl cellosolve, butyl cellosolve, phenyl cellosolve, propylene glycol monomethyl ether, propylene glycol monoethyl ether, propylene glycol monopropyl ether, propylene glycol monobutyl ether, propylene glycol monophenyl ether or mixture thereof. More preferable embodiment of said ether solvent is dimethyl ether.

The mass ratio of said solvent(s) in the composition, to the total mass of the composition is preferably 70-99.95 mass %, more preferably 80-99.90 mass %, further preferably 90-99.90 mass %, furthermore preferably 95-99.50 mass %. One embodiment of the mass ratio of said water to the sum of other solvents is preferably 80-100 mass %, more preferably 90-100 mass %, further preferably 95-100 mass %, furthermore preferably 99-100 mass %. The said solvent is preferably water, ethanol, dimethyl ether or mixture thereof. The solvent consisting of water is one preferred embodiment to avoid unnecessary effect for animals.

The mass ratio of the phosphor(s) to the total mass of the composition is preferably 0.05-30 mass %, more preferably 0.1-10 mass %, further preferably 0.5-5 mass %, furthermore preferably 0.8-3 mass %. In the case the composition is liquid, the applied amount of the phosphor(s) on a plant (preferably leaves) depends on the phosphor's concentration and the composition's dose to be applied. The skilled person can control them based on an applied measure, a purpose, plant species, and so on. Of course, the sum of the mass ratio of said solvent and the mass ratio of the phosphor(s) to the total mass of the composition doesn't exceed 100 mass %.

The mol/L of the phosphor(s) in the composition is preferably 10⁻⁷-10⁻² mol/L, more preferably 10⁻-10⁻³ mol/L, further preferably 10⁻⁵-10⁻⁴ mol/L. In the case the phosphor has variety range of its molecular weight, known methods to get an average molecular weight (preferably a weight average molecular weight) can be used to calculate its mol/L (molar concentration).

Base Composition

Inventors found a method for manufacturing a composition comprising adding at least one phosphor into a base composition. The base composition comprises at least one solvent. The definitions and embodiments of the phosphor and the solvent of this manufacturing method are independently same to described above. Before adding to the base composition, the phosphor can be solid state, and can be dissolved or dispensed in solvent. Some phosphors are good at dissolved by organic solvent. For avoiding evaporated or remained organic solvent affect the plant, soil or animals (including human), the skilled person can decrease the organic solvent concentration in the composition by diluting in the base composition. One preferable embodiment of the mass ratio of water to the total mass of the base composition is preferably 80-100 mass %, more preferably 90-100 mass %, further preferably 95-100 mass %, furthermore preferably 99-100 mass %.

As described above, the mol/L of the phosphor(s) in the composition is preferably 10⁻⁷-10⁻² mol/L. Inventors provide pre-mix composition having 5-10,000 times dense the phosphor(s) concentration than one of the final composition applied to at least one portion of a plant. Such dense pre-mix composition is good for transportation and storage, and can be diluted with solvent or a base composition before actual use (e.g., applying). And inventors provide a container comprising the above said pre-mix composition. For such use, a container with cap to keep the composition inside, or a shakable style container is desirable.

The base composition can be at least one selected from the group consisting of a pesticide formulation and a fertilizer formulation. One embodiment of the manufacturing method is adding phosphor (or phosphor with a matrix material(s)) into the pesticide formulation and/or fertilizer formulation to make a composition before applying it to plant. Pesticide formulation can be at least one selected from the group consisting of an herbicide, insecticide, insect growth regulator, nematicide, termiticide, molluscicide, piscicide, avicide, rodenticide, predacide, bactericide, insect repellent, animal repellent, antimicrobial, fungicide, disinfectant, and sanitizer formulation. Known fertilizer formulation can be used for this manufacturing method. A fertilizer (fertiliser) formulation can comprise natural or synthetic material. Components of the phosphor can function as fertilizer by themselves, and can be absorbed by plant root when swept away from the leave surface.

Applying the Composition to a Plant

This invention provides a method comprising applying the composition to at least one portion of a plant.

This applying method can set the phosphor on at least one portion of a plant (preferably on the leaves), which has a peak emission light wavelength in the range of less than 500 nm or more than 600 nm (preferably 400-500 nm or 600-750 nm, more preferably 430-500 nm or 600-730 nm). The plant described in this specification comprises any organism belonging to Kingdom Plantae. It is preferable embodiment of the invention that the plant is capable of photosynthesis by itself or comprises other organism (e.g., photosynthetic bacteria) inside the plant.

It is one embodiment of the invention that applying the composition to the surface of a single or a plurality of leaves of a plant. If the method applies composition on leaves intentionally, incidental applying to another portion (e.g. stem) is acceptable.

And it is another embodiment of the invention that applying the composition to the surface of a single or a plurality of stems of a plant. To applying a plant which photosynthesize in its stem(s) mainly, this method is preferable. Asparagus is one example for such plant.

This invention provides a method producing a plant(s) with applying the composition to at least one portion of a plant (preferably to the surface of a plant leaves). And this invention provides a method controlling (preferably enhancing) a plant condition, preferably controlling a photosynthesis a plant(s) with applying the composition to at least one portion of a plant (preferably to the surface of a plant leaves).

In the case the composition doesn't comprises any solvent, the composition can be applied to at least one portion of a plant (preferably to the surface of the plant leaves) by powdering, loading or combination thereof, preferably by powdering. An applied amount of the composition as average can be 0.000001-0.001 g/cm², preferably 0.00001-0.0001 g/cm², and more preferably 0.00003-0.00008 g/cm².

The leaves area of 1 plant can be measured by known method and device. A leaf area meter can be used to measure it. One embodiment is a LI3000C Area Meter (Li-COR Corp.). The leaves area can be measured by separating all leaves from 1 plant body, getting a photo image or scan each 1 leaf, and processing these images. The areas of any part of a plant (for example photosynthesis organ) can be measured by known method also.

In the case the composition comprises a solvent(s), the composition can be applied to at least one portion of a plant (preferably to the surface of the plant leaves) by spraying, watering, dropping, dipping, coating or combination of thereof, preferably by spraying. One embodiment of said coating is brush coating. An average amount of the composition to be applied to at least one portion of a plant (preferably to the surface of the plant leaves) can be 0.0005-0.1 mL/cm² of the surface, preferably 0.001-0.01 mL/cm² of the surface.

The composition can be applied one or more times during the growing season of the plant. Growing season can be a period from the first photosynthesis organ (e.g., leaf) develop until the whole flesh weight of a plant become plateaued. The total timing of the composition to be applied can be controlled by applied amount and/or additive(s). A spreading agent can help the phosphor remain on the plant (preferably leaves). The timing can be 1-10 times/1 plant generation, preferably 1-5 times/1 plant generation, more preferably 1-4 times/1 plant generation.

The plant can be flowers, vegetables, fruits, grasses, trees and horticultural crops (preferably flowers and horticultural crops, more preferably flowers). As one embodiment of the invention, the plant can be foliage plants.

Exemplified embodiments of grasses are a poaceae, bambuseae (preferably sasa, phyllostachys), oryzeae (preferably oryza), pooideae (preferably poeae), triticeae (preferably elymus), elytrigia, hordeum, triticum, secale, arundineae, centotheceae, chloridoideae, Hordeum vulgare, Avena sativa, Secale cereal, andropogoneae (preferably coix), cymbopogon, saccharum, sorghum, zea (preferably Zea mays), Sorghum bicolor, Saccharum officinarum, Coix lacryma-jobi var., paniceae (preferably panicum), setaria, echinochloa (preferably Panicum miliaceum), Echinochloa esculenta, and Setaria italic. Embodiments of vegetables are stem vegetables, leaves vegetables, flowers vegetables, stalk vegetables, bulb vegetables, seed vegetables (preferably beans), roots vegetables, tubers vegetables, and fruits vegetables.

One embodiment of the plant can be Gaillardia, Lettuce, Rucola, Komatsuna (Japanese mustard spinach), Radish (preferably Gaillardia, Lettuce, or Rucola), Campanula rapunculus, Rudbeckia, Edamame (Glycine max), or Arabidopsis thaliana (preferably Gaillardia, Lettuce, Rucola, Komatsuna or Radish, more preferably Gaillardia, Lettuce, or Rucola).

The environment of growing plant can be natural environment, a green house, a plant factory and indoor cultivation, preferably natural environment and a green house. One embodiment of the natural environment is an outside farm.

A Plant Coated by at Least One Species of Phosphor

As one embodiment, inventors provide a plant coated by at least one species of phosphor having a peak emission light wavelength less than 500 nm or more than 600 nm. The phosphor is set on the plant by applying method described above. And the plant can be produced or controlled (preferably enhanced) its photosynthesis with the applying method.

As one embodiment, total amount of the phosphor on the plant is in the range of 0.000001-0.001 g/cm², preferably 0.00001-0.0001 g/cm², more preferably 0.00003-0.00008 g/cm².

Use of the Composition and/or Phosphor

As one aspect of the invention, it is provided an use of the composition described above, for improvement of controlling property of plant condition, preferably controlling of a plant height; controlling of color of fruits; promotion and inhibition of germination; controlling of synthesis of chlorophyll and carotenoids preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites (polyphenols, anthocyanins); controlling of a disease resistance of plants; controlling of ripening of fruits, or controlling of weight of plant.

And it is also provided a use of a phosphor having a peak emission light wavelength less than 500 nm or more than 600 nm for agriculture. For such use, it is preferable embodiment use of phosphor for improvement of controlling property of plant condition, preferably controlling of a plant height; controlling of color of fruits; promotion and inhibition of germination; controlling of synthesis of chlorophyll and carotenoids preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites (polyphenols, anthocyanins); controlling of a disease resistance of plants; controlling of ripening of fruits, or controlling of weight of plant.

### PREFERRED EMBODIMENTS TO PRACTICE THIS INVENTION

To practice this invention, below described embodiments can be preferred.

### Embodiment 1

An agriculture composition comprising at least one phosphor, wherein the phosphor has a peak emission light wavelength in the range of 430-500 nm or 600-730 nm.

### Embodiment 2

The agriculture composition according to embodiment 1 further comprising an additive, wherein the additive is at least one selected from the group consisting of a spreading agent or a surface treatment agent.

### Embodiment 3

The agriculture composition according to embodiment 1 or 2 further comprising at least one solvent, wherein

the solvent comprises at least one selected from the group of water and organic solvent, and

preferably the organic solvent comprises at least one selected from the group of alcohol solvent and ether solvent.

### Embodiment 4

The agriculture composition according to embodiment 3, wherein

the mass ratio of the solvent to the total mass of the agriculture composition is 70-99.95 mass %, and

the mass ratio of the phosphors to the total mass of the agriculture composition is 0.05-30 mass %.

### Embodiment 5

The agriculture composition according to one or more of embodiments 1 to 4, wherein

the phosphor is at least one selected from the group consisting of an inorganic phosphor or an organic phosphor,

the inorganic phosphor is at least one selected from the group consisting of sulfides, thiogallates, nitrides, oxy-nitrides, silicates, metal oxides, apatites, phosphates, selenides, borates and carbon materials, and

the organic phosphor is at least one selected from the group consisting of fluorescein derivative, rhodamine derivative, coumarin derivative, pyrene derivative, cyanine derivative, perylene derivative, and di-cyano-methylene derivative.

### Embodiment 6

The agriculture composition according to one or more of embodiments 1 to 5, wherein

the phosphor is at least one metal oxide phosphor represented by following formula (I),

C1ₚC2_{q}C3ᵣC4ₛOₜ:MC (I)

wherein C1 is a monovalent cation which is at least one selected from the group consisting of Li, Na, K, Rb and Cs,

C2 is a divalent cation which is at least one selected from the group consisting of Mg, Zn, Cu, Co, Ni, Fe, Ca, Sr, Ba, Mn, Ce and Sn,

C3 is a trivalent cation which is at least one selected from the group consisting of Y, Gd, Lu, Ce, La, Tb, Sc, Sm, Al, Ga, and In,

C4 is a tetravalent cation which is at least one selected from the group consisting of Si, Ti, and Ge,

MC is a metal cation which is at least one selected from the group consisting of Cr³⁺, Eu²⁺, Mn²⁺, Mn⁴⁺, Fe³⁺, and Ce³⁺, and

p, q, r, s and t are integers on or more than 0, satisfying that (1p+2q+3r+4s)=2t, and at least one of p, q, r and s is on or more than 1.

### Embodiment 7

The agriculture composition according to one or more of embodiments 1 to 6, wherein

the phosphor is at least one inorganic phosphor,

the inorganic phosphor is at least one selected from the group consisting of Cr activated metal oxide phosphors represented by following formulae (II) or (III) and Mn activated metal oxide phosphors represented by following formulae (IV) or (V),

AₓB_{y}O_{z}:Cr³⁺ (II)

wherein A is a trivalent cation and is selected from the group consisting of Y, Gd, Lu, Ce, La, Tb, Sc, and Sm, B is a trivalent cation and is selected from the group consisting of Al, Ga, Lu, Sc, and In; x and y are integers; x≥0; y≥1; and 1.5(x+y)=z;

XₐZ_{b}O_{c}:Cr³⁺ (III)

wherein X is a divalent cation and is selected from the group consisting of Mg, Zn, Cu, Co, Ni, Fe, Ca, Sr, Ba, Mn, Ce and Sn; Z is a trivalent cation and is selected from the group consisting of Al, Ga, Lu, Sc and In; a and b are integers; b≥0; a≥1; and (a+1.5b)=c;

C2_{q}C3ᵣC4Oₜ:MC²⁺ (IV)

wherein MC²⁺ is a divalent metal cation selected from “Eu²⁺”, “Mn²⁺”, or “Eu²⁺, Mn²⁺”;

the definitions of C2, C3, C4, q, r, s and t are independently same to embodiment 6;

C2_{q}C3ᵣC4ₛOₜ:Mn⁴⁺ (V)

wherein the definitions of C2, C3, C4, q, r, s and t are independently same to embodiment 6.

### Embodiment 8

The agriculture composition according to one or more of embodiments 1 to 7, wherein

the phosphor is at least one inorganic phosphor, and

the inorganic phosphor is at least one selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₁₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Mg₈Ge₂O₁₁F₂:Mn⁴⁺, CaGa₂S₄:Mn²⁺, Gd₃Ga₅O₁₂:Cr³⁺, Gd₃Ga₅O₁₂:Cr³⁺,Ce³⁺, (Ca,Ba,Sr)MgSi₂O₆:Eu²⁺, Mn²⁺, (Ca,Ba,Sr)₂MgSi₂O₇:Eu²⁺, Mn²⁺, (Ca,Ba,Sr)₃MgSi₂O₈:Eu²⁺, Mn²⁺, ZnS, InP/ZnS, CuInS₂, CuInSe₂, CuInS₂/ZnS and carbon quantum dot.

### Embodiment 9

The agriculture composition according to one or more of embodiments 1 to 8, further comprising at least one selected from the group consisting of an adjuvant, a dispersant, a surfactant, a fungicide, an antimicrobial agent, and an antifungal agent.

### Embodiment 10

A method for manufacturing the agriculture composition according to one or more of embodiments 1 to 9, comprising adding at least one phosphor into a base composition, wherein

the base composition comprises at least one solvent,

the solvent comprises at least one selected from the group of water and organic solvent, and

preferably the organic solvent comprises at least one selected from the group of alcohol solvent and ether solvent.

### Embodiment 11

The method for manufacturing an agriculture composition according to embodiment 10, wherein the base composition is at least one selected from the group consisting of a pesticide and a fertilizer.

### Embodiment 12

A method comprising applying the agriculture composition according to one or more of embodiments 1 to 11, to the surface of a plant leaves.

### Embodiment 13

A method for producing or enhancing a photosynthesis of one or more plant, by applying method according to embodiment 1216.

### Embodiment 14

The method for producing or enhancing a photosynthesis of one or more plant according to embodiment 13, wherein the average amount of the agriculture composition to be applied to the surface of the plant leaves is 0.0005-0.1 mL/cm² of the surface.

### Embodiment 15

The method for producing or enhancing a photosynthesis of one or more plant according to embodiment 13 or 14, wherein the agriculture composition is applied to the surface of the plant by spraying, watering, dropping, dipping, coating or combination of thereof.

### Embodiment 16

The method for producing or enhancing a photosynthesis of one or more plant according to one or more of embodiments 13 to 15, wherein the agriculture composition is applied one or more times during the growing season of the plant.

The synthesis examples and working examples below provide descriptions of the present inventions but not intended to limit scopes of the inventions.

### WORKING EXAMPLES

### Synthesis Example 1: Synthesis of Al₂O₃:Cr³⁺

The precursors of Al₂O₃:Cr³⁺ phosphor is synthesized by a co-precipitation method. The raw materials of Aluminium Nitrate Nonahydrate and Chromium(III) nitrate nonahydrate are dissolved in deionized water with a stoichiometric molar ratio of 0.99:0.01. NH₄HCO₃ is added to the mixed chloride solution as a precipitant, and the mixture is stirred at 60° C. for 2h. The resultant solution is dried at 95° C. for 12 h, then the preparation of the precursors is completed. The obtained precursors are oxidized by calcination at 1300° C. for 3 h in air. To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature.

The absorption peak wavelengths of Al₂O₃:Cr³⁺ are 410-430 nm and 550-570 nm, the emission peak wavelength is in the range from 680-700 nm, the full width at half maximum (hereafter “FWHM”) of the light emission from Al₂O₃:Cr³⁺ is on or less than 30 nm.

### Working Example 1: Composition 1

10 mL of a spreading agent (Approach BI, Trade mark, Kao Corp.) is added in 10 L of water, and stirred. Al₂O₃:Cr³⁺ phosphor of Synthesis example 1 is added to the resultant solution to be 1.0% mass concentration (1.0 mass %).

### Working Example 2: Plant Growth Test 1

Hydroponics systems UH-CB01G1 (UING Corp.) are prepared with a white LED light sources at the top of the systems. The systems are set inside of a room.

Light conditions are below. Photosynthetic Photon Flux Density (PPFD) are 200 μmol·m⁻²·s⁻¹. Puts the light on at 6:00 am, puts the light off at 22:00 (light on 16 h/day). Black sheets are set to cover the system for cutting natural light reach plants as like shown in FIG. 1. The sheets are shut unless necessity e.g. watering, evaluation.

During this test, sufficient water is maintained under plants to cover their roots. The temperature is controlled at room temperature, approximately 25° C.

4 seedlings of Lettuce are planted on this system as working example group 1. As comparative example group 1, 4 seedlings are planted on this system.

Composition 1 is sprayed on the working example group 1 approximately uniformly by 10 times spraying at 1^{st} day, 8^{th} day and 16^{th} day from planting date. The 10 times spraying volume is approximately 8 mL. Leaves weights at 23rd days from planting date are evaluated as below. All leaves of 1 plant are separated. Other parts of plant (e.g. stem, root) are not used for this evaluation. Soon, fresh leaves weight of 1 plant is weighted. Leaves are dried in a desiccator at 85° C. for more than 24 h. Then dried leaves weight of 1 plant is weighted. Average of 4 plants in working example group 1 is described in below Table 1. Same procedures are done to evaluate the comparative example group 1.

TABLE 1

| | Working example | Comparative |
|---|---|---|
| | group 1 | example group 1 |
| Fresh leaves weight (g) | 47.35 | 42.76 |
| Dried leaves weight (g) | 2.01 | 1.72 |

This test shows that the working example plants grow more than the comparative example ones.

### Working Example 3 and 4: Composition 2 and 3

Composition 2 and 3 are prepared same to the working example 1 with changing Al₂O₃:Cr³⁺ phosphor concentration as 0.25 mass % and 0.50 mass %.

### Working Example 5: Plant Growth Test 2

Below experiments are conducted in a greenhouse under natural light (sun light). The greenhouse is located at Tottori prefecture, Japan. The starting date is in April.

8 seedlings (38 days after seeded) of Gaillardia are planted in soil. Later, normal watering is conducted 1 time/1 day on all seedlings and soil by a watering can.

10 days after planting, the composition 1 (working example 1, 1.0 mass %) is sprayed on 2 seedlings by 4 times spraying. The 4 times spraying volume is approximately 4 mL.

Same procedures are taken with the composition 2 (working example 3, 0.25 mass %) sprayed on 2 seedlings. Same procedures are taken with the composition 3 (working example 4, 0.50 mass %) sprayed on 2 seedlings.

FIG. 2 shows those plants 57 days after planting.

This test shows that the working example plants grow more than the comparative example ones. 1.0 mass % sprayed group bloomed at 57 days after planting. The growth is accelerated by a dense concentration composition. And a concentration dependency is observed in this test.

### Synthesis Example 2: Synthesis of Mg₂TiO₄:Mn⁴⁺

The precursors of Mg₂TiO₄:Mn⁴⁺ phosphor is synthesized by a solid-state reaction. The raw materials of Magnesium oxide, Titanium oxide and Manganese oxide are prepared with a stoichiometric molar ratio of 2.000:0.999:0.001. These chemicals are put in a mortar and mixed by a pestle for 30 minutes. The resultant is oxidized by calcination at 1000° C. for 3 h in air. To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature.

The absorption peak wavelengths of Mg₂TiO₄:Mn⁴⁺ are 300-340 nm and 460-520 nm, the emission peak wavelength is in the range from 650-670 nm, the FWHM of the light emission from Mg₂TiO₄:Mn⁴⁺ is on or less than 60 nm.

### Working Example 6: Composition 4

Composition 4 is prepared same to the working example 1 with changing from Al₂O₃:Cr³⁺ (synthesis example 1) to Mg₂TiO₄:Mn⁴⁺ (synthesis example 2).

### Working Example 7: Plant Growth Test 3

Same tests are done same to the working example group 2 with changing from the composition 1 to the composition 4.

Without using composition 1 to 4, Comparative example group 2 are grown in parallel.

Leaves weights at 23^{rd} days from planting date are evaluated as same procedures described in above working example 2. The results are shown in below Table 2.

TABLE 2

| | Working example | Comparative |
|---|---|---|
| | group 2 | example group 2 |
| Fresh leaves weight (g) | 46.4 | 42.04 |
| Dried leaves weight (g) | 2.04 | 1.75 |

This test shows that the working example plants grow more than the comparative example ones.

### Working Example 8: Plant Growth Test 4

Below experiments are conducted in a greenhouse under natural light (sun light). 12 Komatsuna (Japanese mustard spinach) seedlings are planted in soil. 6 seedlings are working example group 3 (composition 4 spraying) and other 6 seedlings are comparative example group 3 (water spraying). 1 day after planting, the composition 4 is sprayed on working example group 3 (6 seedlings) by 10 times spraying. The 10 times spraying volume is approximately 8 mL. 1 day after planting, water is sprayed on comparative example group 3 (6 seedlings) by 10 times spraying. The 10 times spraying volume is approximately 8 mL.

Same procedures are taken on 8^{th}, 16^{th}, 21^{st} and 28^{th} days after planting date.

Leaves weights at 35^{th} days from planting date are evaluated as same procedures described in above working example 2. The results are shown in below Table 3.

TABLE 3

| | Working example | Comparative |
|---|---|---|
| | group 3 | example group 3 |
| Fresh leaves weight (g) | 4.42 | 3.55 |
| Dried leaves weight (g) | 0.79 | 0.68 |

This test shows that the working example plants grow more than the comparative example ones.

### Synthesis Example 3: Synthesis of Y₂MgTiO₆:Mn⁴⁺

The phosphors precursors are synthesized by a conventional polymerized complex method. The raw materials of yttrium oxide, magnesium oxide, titanium oxide and manganese oxide are prepared with a stoichiometric molar ratio of 2.000:1.000:0.999:0.001. These chemicals are put in a mortar and mixed by a pestle for 30 minutes. The resultant materials are oxidized by firing at 1500° C. for 6 h in air.

To confirm the structure of the resultant materials, XRD measurements are performed using an X-ray diffractometer (RIGAKU RAD-RC).

Photoluminescence (PL) spectra are measured using a Spectro fluorometer (JASCO FP-6500) at room temperature.

The absorption peak wavelengths of Y₂MgTiO₆:Mn⁴⁺ are 300-340 nm and 320-490 nm, the emission peak wavelength is in the range from 700 nm.

### Working Example 9: Composition 5

Composition 5 is prepared same to the working example 1 with changing from Al₂O₃:Cr³⁺ (synthesis example 1) to Y₂MgTiO₆:Mn⁴⁺ (synthesis example 3).

### Working Example 10: Plant Growth Test 5

Below experiments are conducted in a greenhouse under natural light (sun light). 12 Radish seedlings are planted in soil. 6 seedlings are working example group 4 (composition 5 spraying) and other 6 seedlings are comparative example group 4 (water spraying).

1 day after planting, the composition 4 is sprayed on working example group 3 (6 seedlings) by 10 times spraying. The 10 times spraying volume is approximately 8 mL. 1 day after planting, water is sprayed on comparative example group 3 (6 seedlings) by 10 times spraying. The 10 times spraying volume is approximately 8 mL.

Same procedures are taken on 8^{th} and 16^{th} days after planting date.

Roots weights at 23′ days from planting date are evaluated as same procedures described in above working example 2. In this example, not leaves but roots are treated and evaluated. The results are shown in below Table 4.

TABLE 4

| | Working example | Comparative |
|---|---|---|
| | group 4 | example group 4 |
| Fresh roots weight (g) | 5.36 | 4.43 |
| Dried roots weight (g) | 0.33 | 0.26 |

This test shows that the working example plants grow more than the comparative example ones.

### Synthesis Example 4: Synthesis of Ba₂YTaO₆:Mn⁴

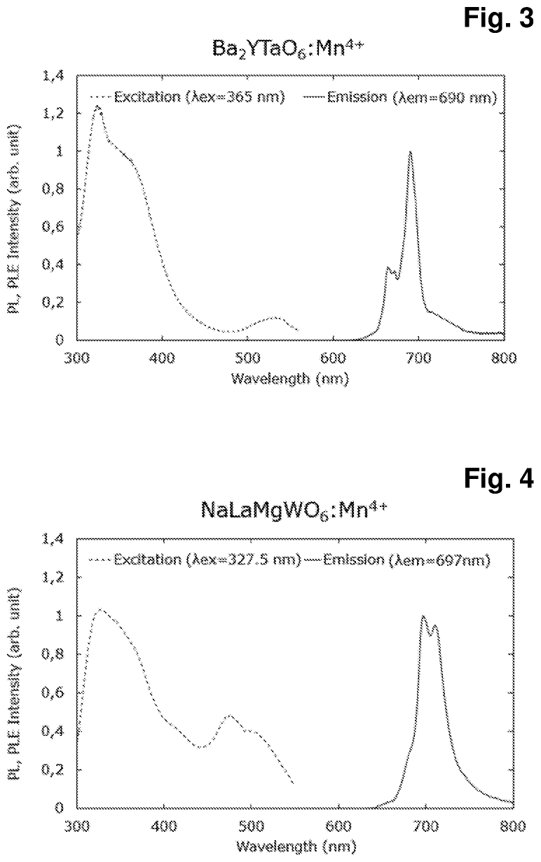

The present example refers to the synthesis of the phosphor Ba₂YTaO₆:Mn⁴⁺ with a Mn concentration of 1 mol %. The phosphor is prepared according to conventional solid-state reaction methods, using Ba₂CO₃, Y₂O₃, Ta₂O₅ and MnO₂ as starting materials. These chemicals are mixed according to their stoichiometric ratio and mixed with acetone in an agate mortar. The powder thus obtained is pelletized at 10 MPa, placed into an alumina container and heated at 1400° C. for 6 h in the presence of air. After cooling the residue is well grinded for characterization. For confirmation of the structure, XRD measurements are performed using an X-ray diffractometer. Photoluminescence (PL) spectra is taken using a spectrofluorometer at room temperature. The XRD patterns proofs that the main phase of the product consisted of Ba₂YTaO₆. The photoluminescence excitation spectrum shows a UV region from 300-400 nm while the emission spectrum exhibits a deep red region from 630-710 nm. Excitation and emission spectra are provided in FIG. 3.

The absorption peak wavelengths of Ba₂YTaO₆:Mn⁴⁺ is 310-340 nm, and the emission peak wavelength is in the range from 680-700 nm.

### Synthesis Example 5: Synthesis of NaLaMgWO₆:Mn⁴⁺

The present example refers to the synthesis of the phosphor NaLaMgWO₆:Mn⁴⁺ with a Mn concentration of 1 mol %. The phosphor is prepared according to conventional solid-state reaction methods, using Na₂CO₃, La₂O₃, MgO, WO₃ and MnO₂ as starting materials. La₂O₃ is preheated at 1200° C. for 10 h in the presence of air. The chemicals are mixed according to their stoichiometric ratio and mixed with acetone in an agate mortar. The powder thus obtained is pelletized at 10 MPa, placed into an alumina container and heated at 1300° C. for 6 h in the presence of air. After cooling the residue is well grinded for characterization. For confirmation of the structure, XRD measurements are performed using an X-ray diffractometer. Photoluminescence (PL) spectra are taken using a spectrofluorometer at room temperature. The XRD patterns proofs that the main phase of the product consisted of NaLaMgWO₆. The photoluminescence excitation spectrum shows a UV region from 300-400 nm while the emission spectrum exhibited a deep red region from 660-750 nm. Excitation and emission spectra are provided in FIG. 4.

The absorption peak wavelengths of NaLaMgWO₆:Mn⁴⁺ is 310-330 nm, and the emission peak wavelength is in the range from 690-720 nm.

### Working Example 11: Plant Growth Test 6

In order to evaluate the effect of the phosphors on plant growth tests using hydroponic plant systems are conducted. Two aqueous solutions are prepared, one comprising 1 wt. % NaLaMgWO₆:Mn⁴⁺ phosphor (Synthesis Example 5) and the other free of the phosphor. The tests are performed with hydroponic system of UING Corp. using a white LED on top of the boxes comprising young lettuce and rucola plants and enough water. The solutions are sprayed on the first day of the test series and on day 8. After day 16 the plants treated with the phosphor solution shows 10% increase in height versus the comparison.

### Synthesis Example 6: Synthesis of Si₅P₆O₂₅:Mn⁴⁺

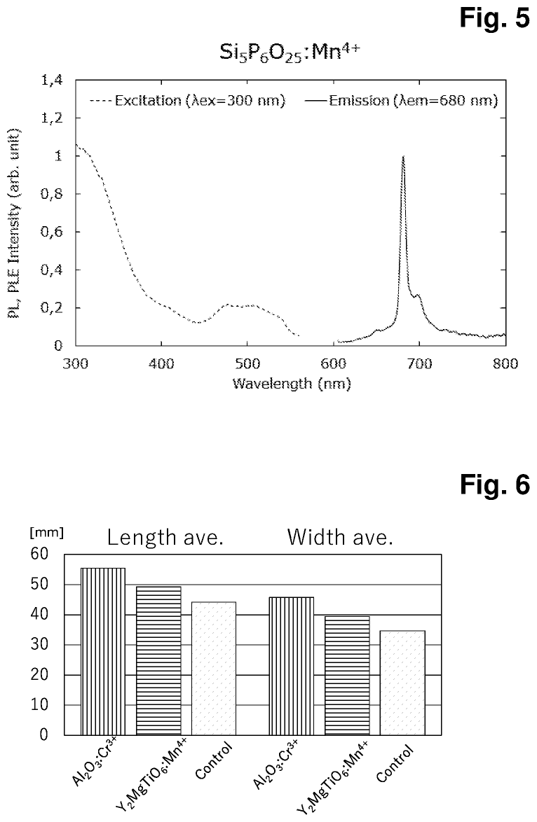

The present example refers to the preparation of the phosphor Si₅P₆O₂₅:Mn⁴⁺ with an Mn concentration of 0.5 mol %. The phosphor is prepared according to conventional solid-state reaction methods, using SiO₂, NH₄H₂PO₄ and MnO₂ as starting materials. The chemicals are mixed according to their stoichiometric ratio and mixed with acetone in an agate mortar. The powder thus obtained is pelletized at 10 MPa, placed into an alumina container, pre-heated 300° C. for 6 h. The pre-heated powder is grinded, pelletized at 10 MPa, placed again in an alumina container and heated at 1000° C. for another 12 hours in the presence of air. After cooling the residue is well grinded for characterization. For confirmation of the structure, XRD measurements are performed using an X-ray diffractometer. Photoluminescence (PL) spectra are taken using a spectrofluorometer at room temperature. The XRD patterns proofs that the main phase of the product consisted of Si₅P₆O₂₅. The photoluminescence excitation spectrum shows a UV region from 300 nm to 400 nm while the emission spectrum exhibited a deep red region in the range from 670-690 nm. Excitation and emission spectra are provided in FIG. 5.

### Working Example 12: Plant Growth Test 7

In order to evaluate the effect of the phosphors on plant growth tests using hydroponic plant systems are conducted. Two aqueous solutions are prepared, one comprising 1 wt. % Si₅P₆O₂₅:Mn⁴⁺ phosphor (Synthesis Example 6) and the other free of the phosphor. The tests are performed with hydroponic system of UING Corp. using a white LED on top of the boxes comprising young lettuce and rucola plants and enough water. The solutions are sprayed on the first day of the test series and on day 8. After day 16 the plants treated with the phosphor solution shows 10% increase in height versus the comparison.

### Synthesis Example 7: Synthesis of CaMgSi₂O₆:Eu²⁺, Mn²⁺

The phosphor precursors of CaMgSi₂O₆:Eu²⁺, Mn2⁺ are synthesized by a conventional co-precipitation method.

CaCl₂.2H₂O (0.0200 mol, Merck), SiO₂ (0.05 mol, Merck), EuCl₃.6H₂O (0.0050 mol, Auer-Remy), MnCl₂.4H₂O (0.0050 mol, Merck), and MgCl₂. 4H₂O (0.0200 mol, Merck) are dissolved in deionized water. NH₄HCO₃ (0.5 mol, Merck) is dissolved separately in deionized water.

The two aqueous solutions are simultaneously stirred into deionized water. The combined solution is heated to 90° C. and evaporated to dryness. Then, the residue is annealed at 1000° C. for 4 hours under an oxidative atmosphere, and the resulting oxide material is annealed at 1000° C. for 4 hours under a reductive atmosphere.

To confirm the structure of the resultant materials, XRD measurements are performed using an X-ray diffractometer (RIGAKU RAD-RC).

Photoluminescence (PL) spectra is measured using a Spectro fluorometer (JASCO FP-6500) at room temperature. The emission peak wavelengths of CaMgSi₂O₆:Eu²⁺, Mn2⁺ is 570-600 nm and 670-710 nm.

### Working Example 13: Plant Growth Test 8

In order to evaluate the effect of the phosphors on plant growth, tests under natural light in green house are conducted. Four aqueous solutions are prepared, each three comprising 0.25 mass %, 0.50 mass %, 1.00 mass % Al₂O₃:Cr³⁺ phosphor (Synthesis Example 1) and the other free of the phosphor (Control, 0 mass %). 2 weeks after seeding, 4 seedlings of Campanula rapunculus are planted in soil. 4 weeks after planting, each solutions are sprayed to the plants. 8 weeks after spraying, the height of each seedlings is evaluated. Versus the control (0 mass % treated plant), each plant treated with 0.25 mass %, 0.50 mass % and 1.00 mass % shows 16%, 24% and 35% increases in height.

### Working Example 14: Plant Growth Test 9

In order to evaluate the effect of the phosphors on plant growth, tests under natural light in green house are conducted. Two aqueous solutions are prepared, one comprising 1.00 mass % Al₂O₃:Cr³⁺ phosphor (Synthesis Example 1) and the other free of the phosphor (Control, 0 mass %). 2 weeks after seeding, 2 seedlings of Rudbeckia Toto (trade mark) Gold are planted in soil. 4 weeks after planting, each solutions are sprayed to the plants. 8 weeks after spraying, the height of each seedlings is evaluated. Versus the control (0 mass % treated plant), the plants treated with 1.00 mass % shows 29% increases in height.

### Working Example 15: Plant Growth Test 10

In order to evaluate the effect of the phosphors on plant growth, tests under natural light in green house are conducted. These tests are conducted from July in Kanagawa prefecture, Japan. 3 aqueous solutions are prepared, two each comprising 1.00 mass % Al₂O₃:Cr³⁺ phosphor (Synthesis Example 1) and 1.00 mass % Y₂MgTiO₆:Mn⁴⁺ phosphor (Synthesis Example 3), and the other free of the phosphor (Control, 0 mass %). 2 weeks after seeding, seedlings of Komatsuna (Japanese mustard spinach) are planted in soil, and are treated with each solutions by spraying. 13 days after then, 20 spraying is conducted. 14 days after 2⁰ spraying, 3′^{d} spraying is conducted. 7 days after 3^{rd} spraying (in September), leaves of Komatsuna are harvested.

Length and width of leaves are measured. Average of them are shown in below FIG. 6.

### Working Example 16: Plant Growth Test 11

In order to evaluate the effect of the phosphors on plant growth, tests under natural light in green house are conducted. These tests are conducted from July in Kanagawa prefecture, Japan. 2 aqueous solutions are prepared, one comprising 1.00 mass % Mg₂TiO₄:Mn⁴⁺ phosphor (Synthesis Example 2), and the other free of the phosphor (Control, 0 mass %). 20 days after seeding, seedlings of Edamame (Glycine max) are planted in soil, and are treated with each solutions by spraying. 21 days after then, 2^{nd} spraying is conducted. 14 days after 2^{nd} spraying (in September), shells of Edamame are harvested.

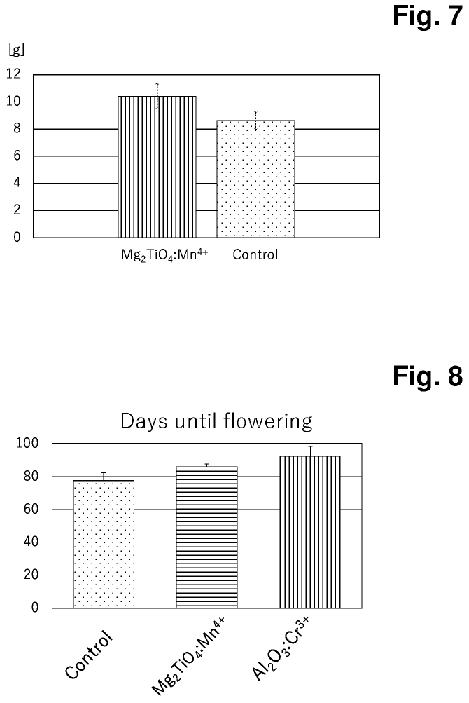

Fresh weight of shells is measured. Average of them are shown in below FIG. 7.

### Working Example 17: Plant Growth Test 12

In order to evaluate the effect of the phosphors on plant growth, tests under LED light in laboratory room are conducted. Light conditions are 8 hours LED white light PPFD:150, 16 hours dark in each day. 3 aqueous solutions are prepared, two each comprising 1.00 mass % Al₂O₃:Cr³⁺ phosphor (Synthesis Example 1) and Mg₂TiO₄:Mn⁴⁺ phosphor (Synthesis Example 2), and the other free of the phosphor (Control, 0 mass %).

2 weeks after seeding, seedlings of Arabidopsis thaliana are treated with phosphor solutions by spraying at the frequency of 1 time/1 week.

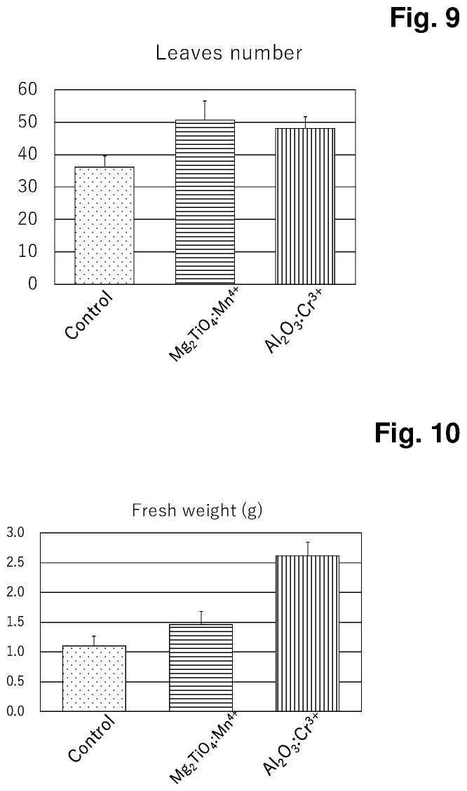

As shown in below FIG. 8, phosphor treating change the growing duration (days) from seeding until flowering begins. At the timing of flowering begins, leaves number of each seedlings are counted as show in below FIG. 9, and each seedling is harvested and fresh weight is measured as shown in below FIG. 10. Each numbers are average ones of each group.

Phosphor treating slightly increases the growing duration of Arabidopsis thaliana until flowering. And phosphor treating increases leaves numbers and fresh weight of Arabidopsis thaliana.

### Synthesis Example 8: Synthesis of Ca₁₄Al₁₀Zn₆O₃₅:Mn⁴⁺

The precursors of Ca₁₄Al₁₀Zn₆O₃₅:Mn⁴⁺ are synthesized by a solid phase reaction. The raw materials of calcium oxide, aluminium oxide, zinc oxide and manganese oxide are prepared with a stoichiometric molar ratio of 14.000:9.850:6.000:0.015. The chemicals are put in a mortar and mixed by a pestle for 30 minutes. The resultant materials are oxidized by firing at 1200° C. for 6 h in air.

To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature. The absorption peak wavelengths are in the range of 280-340 nm, and 430-480 nm. The emission peak wavelength is in the range from 690-740 nm.

1. A composition comprising at least one phosphor, wherein the phosphor has a peak emission light wavelength in the range of less than 500 nm or more than 600 nm.

2. The composition according to claim 1, wherein the phosphor has a peak emission light wavelength in the range of 400-500 nm or 600-750 nm.

3. The composition according to claim 1, wherein the composition comprises at least one matrix material suitable for agriculture.

4. The composition according to claim 1, wherein the phosphor is a non-toxic phosphor, preferably it is an edible phosphor.

5. The composition according to claim 1, further comprising an additive, wherein the additive is preferably at least one selected from the group consisting of a spreading agent or a surface treatment agent.

6. The composition according to claim 1, further comprising at least one solvent, wherein
the solvent comprises at least one solvent selected from the group of water and organic solvent, and
preferably the organic solvent comprises at least one selected from the group of alcohol solvent and ether solvent.

7. The composition according to claim 6, wherein
the mass ratio of the solvent to the total mass of the composition is 70-99.95 mass %, and
the mass ratio of the phosphors to the total mass of the composition is 0.05-30 mass %.

8. The composition according to claim 1, wherein
the phosphor is at least one selected from the group consisting of an inorganic phosphor or an organic phosphor,
preferably the inorganic phosphor is at least one selected from the group consisting of metal oxides, silicates, halosilicates, phosphates, halophosphates, borates, borosilicates, aluminates, gallates, alumosilicates, molybdates, tungstates, sulfates, sulfides, selenides, tellurides, nitrides, oxynitrides, SiAlONs, halides and oxy compounds (preferably oxysulfides or oxychlorides), and
preferably the organic phosphor is at least one selected from the group consisting of fluoresceines, rhodamines, coumarines, pyrenes, cyanines, perylenes, and di-cyano-methylenes.

9. The composition according to claim 1, wherein
the phosphor is at least one metal oxide phosphor represented by following formula (I),
C1ₚC2_{q}C3ᵣC4ₛOₜ:MC (I)
wherein C1 is a monovalent cation which is at least one selected from the group consisting of Li, Na, K, Rb and Cs,
C2 is a divalent cation which is at least one selected from the group consisting of Mg, Zn, Cu, Co, Ni, Fe, Ca, Sr, Ba, Mn, Ce and Sn,
C3 is a trivalent cation which is at least one selected from the group consisting of Y, Gd, Lu, Ce, La, Tb, Sc, Sm, Al, Ga, and In,
C4 is a tetravalent cation which is at least one selected from the group consisting of Si, Ti, and Ge,
MC is a metal cation which is at least one selected from the group consisting of Cr³⁺, Eu²⁺, Mn²⁺, Mn⁴⁺, Fe³⁺, and Ce³⁺, and
p, q, r, s and t are integers on or more than 0, satisfying that (1p+2q+3r+4s)=2t, and at least one of p, q, r and s is on or more than 1.

10. The composition according to claim 1, wherein
the phosphor is at least one inorganic phosphor,
the inorganic phosphor is at least one selected from the group consisting of Cr activated metal oxide phosphors represented by following formulae (II) or (III), Mn activated metal oxide phosphors represented by following formulae (IV) or (V), and metal oxide phosphors represented by following formulae (I′) to (X′) or (VII″),
AₓB_{y}O_{z}:Cr³ (II)
wherein A is a trivalent cation and is selected from the group consisting of Y, Gd, Lu, Ce, La, Tb, Sc, and Sm, B is a trivalent cation and is selected from the group consisting of Al, Ga, Lu, Sc, and In; x and y are integers; x≥0; y≥1; and 1.5(x+y)=z;
XₐZ_{b}O_{c}:Cr³⁺ (III)
wherein X is a divalent cation and is selected from the group consisting of Mg, Zn, Cu, Co, Ni, Fe, Ca, Sr, Ba, Mn, Ce and Sn; Z is a trivalent cation and is selected from the group consisting of Al, Ga, Lu, Sc and In; a and b are integers; b≥0; a≥1; and (a+1.5b)=c;
C2_{q}C3ᵣC4ₛOₜ:MC²⁺ (IV)
wherein MC²⁺ is a divalent metal cation selected from “Eu²⁺”, “Mn²⁺”, or “Eu²⁺,Mn²⁺”;
C2 is a divalent cation which is at least one selected from the group consisting of Mg, Zn, Cu, Co, Ni, Fe, Ca, Sr, Ba, Mn, Ce and Sn,
C3 is a trivalent cation which is at least one selected from the group consisting of Y, Gd, Lu, Ce, La, Tb, Sc, Sm, Al, Ga, and In,
C4 is a tetravalent cation which is at least one selected from the group consisting of Si, Ti, and Ge, and
p, q, r, s and t are integers on or more than 0, satisfying that (1p+2q+3r+4s)=2t, and at least one of p, q, r and s is on or more than 1;
C2_{q}C3ᵣC4ₛOₜ:Mn⁴⁺ (V)
wherein C2 is a divalent cation which is at least one selected from the group consisting of Mg, Zn, Cu, Co, Ni, Fe, Ca, Sr, Ba, Mn, Ce and Sn,
C3 is a trivalent cation which is at least one selected from the group consisting of Y, Gd, Lu, Ce, La, Tb, Sc, Sm, Al, Ga, and In,
C4 is a tetravalent cation which is at least one selected from the group consisting of Si, Ti, and Ge, and
p, q, r, s and t are integers on or more than 0, satisfying that (1p+2q+3r+4s)=2t, and at least one of p, q, r and s is on or more than 1;
AₓB_{y}O_{z}:Mn⁴⁺ (I′)
wherein A is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4;
XₐZ_{b}O_{c}:Mn⁴⁺ (II′)
wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3;
D_{d}EₑO_{f}:Mn⁴⁺ (III′)
wherein D is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19;
D_{g}EₕOᵢ:Mn⁴⁺ (IV′)
wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5g+1.5h)=l, preferably D is La³⁺, E is Al³⁺, Gd³⁺ or a combination of these, g is 1, h is 12, i is 19;
GⱼJₖLₗOₘ:Mn⁴⁺ (V′)
wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga⁺, Lu³⁺, Sc³⁺, La³⁺ and In³⁺; L is a trivalent cation and is selected from the group consisting of Al³⁺, Ga³⁺, Lu³⁺, Sc³⁺, La⁺ and In³⁺; l≥0; k≥0; j≥0; (j+1.5k+1.5l)=m, preferably G is selected from Ca²⁺, Sr²⁺, Ba²⁺ or a combination of any of these, J is Y³⁺, Lu³⁺ or a combination of these, L is Al³⁺, Gd³⁺ or a combination of these, j is 1, k is 1, l is 1, m is 4;
MₙQₒRₚO_{q}:Eu,Mn (VI′)
wherein M and Q are divalent cations and are, independently or dependently of each other, selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; R is Ge³⁺, Si⁺, or a combination of these; n≥1; o≥0; p≥1; (n+o+2.0p)=q, preferably M is Ca²⁺, Sr²⁺, Ba²⁺ or a combination of any of these, Q is Mg²⁺, Ca²⁺, Sr²⁺, Ba²⁺, Zn²⁺ or a combination of any of these, R is Ge³⁺, Si³⁺, or a combination of these, n is 1, o is 1, p is 2, q is 6;
A₅P₆O₂₅:Mn⁴⁺ (VII′)
wherein the component “A” stands for at least one cation selected from the group consisting of Si⁴⁺, Ge⁴⁺, Sn⁴⁺, Ti⁴⁺ and Zr⁴⁺;
(A₁₋ₓMnₓ)₅P₆O₂₅ (VII″)
component A stands for at least one cation selected from the group consisting of Si⁴⁺, Ge⁴⁺, Sn⁴⁺, Ti⁴⁺ and Zr⁴⁺, preferably A is Si⁴⁺; 0<x≤0.5, preferably 0.05<x≤0.4. As a preferred embodiment of the present invention, Mn of formula (VII″) is Mn⁴⁺;
XO₆ (VIII′)
wherein X=(A¹)₂B¹(C¹₍₁₋ₓ₎ Mn⁴⁺_{5/4x}), or X=A²B²C²(D¹_{(1-y)}Mn⁴⁺_{1.5y}), 0<x≤0.5, 0<y≤0.5,
A¹, B¹, C¹, A²⁺, B²⁺, C² and D¹ are independently same to below;
A¹₂B¹C¹O₆: Mn⁴⁺ (IX′)
A¹=at least one cation selected from the group consisting of Mg²⁺, Ca²⁺, Sr²⁺ and Ba²⁺ Zn²⁺, preferably A¹ is Ba²⁺,
B¹=at least one cation selected from the group consisting of Sc³⁺, Y³⁺, La³⁺, Ce³⁺, B³⁺, Al³⁺ and Ga³⁺, preferably B¹ is Y³⁺,
C¹=at least one cation selected from the group consisting of V⁵⁺, Nb⁵⁺ and Ta⁵⁺, preferably C¹ is Ta⁵⁺;
A²B²C²D¹O₆:Mn⁴⁺ (X′)
A²=at least one cation selected from the group consisting of Li⁺, Na⁺, K⁺, Rb⁺ and Cs⁺, preferably A² is Na⁺,
B²=at least one cation selected from the group consisting of Sc³⁺, La³⁺, Ce³⁺, B³⁺, Al³⁺ and Ga³⁺, preferably B² is La⁺,
C²=at least one cation selected from the group consisting of Mg²⁺, Ca²⁺, Sr²⁺, Ba²⁺ and Zn²⁺, preferably C² is Mg²⁺,
D¹=at least one cation selected from the group consisting of Mo⁶⁺ and W⁶⁺, preferably D¹ is W⁶⁺.

11. The composition according to claim 1, wherein the phosphor is selected from the group consisting of Al₂O₃:Cr³⁺, YaAl₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₁₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Mg₈Ge₂O₁₁F₂:Mn⁴⁺, CaGa₂S₄:Mn²⁺, Gd₃Ga₅O₁₂:Cr³⁺, Gd₃Ga₅O₁₂:Cr³⁺, Ce³⁺, (Ca,Ba,Sr)MgSi₂O₆:Eu,Mn, (Ca,Ba,Sr)₂MgSi₂O₇:Eu,Mn, (Ca,Ba,Sr)₃MgSi₂O₈:Eu,Mn, ZnS, InP/ZnS, CuInS₂, CuInSe₂, CuInS₂/ZnS, carbon quantum dot, CaMgSi₂O₆:Eu²⁺, Mn²⁺, Si₅P₆O₂₅:Mn⁴⁺, Ba₂YTaO₆:Mn⁴⁺, NaLaMgWO₆:Mn⁴⁺, Y₂MgTiO₆:Mn⁴⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu2+, NaSrPO₄:Eu²⁺, KBaPO₄:Eu²⁺, KSrPO₄:Eu²⁺, KMgPO₄:Eu²⁺, α-Sr₂P₂O₇:Eu²⁺, α-Ca₂P₂O₇:Eu²⁺, Mg₃(PO₄)₂:Eu²⁺, Mg₃Ca₃(PO₄)₄:Eu²⁺, BaMgAl₁₀O₁₇:Eu²⁺, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, CaAlSiN₃:Eu²⁺, SrAlSiN₃:Eu²⁺, Sr₂Si₅N₈:Eu²⁺, SrLiAlN₄:Eu²⁺, LiAl₅O₈:Cr³⁺, SrAlSi₄N₇:Eu²⁺, Ca₂SiO₄:Eu²⁺, NaMgPO₄:Eu²⁺, CaS:Eu²⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn⁴⁺, YVO₄:Eu³⁺, MgSr₃Si₂O₈:Eu²⁺,Mn²⁺, Y₂O₃:Eu³⁺, Ca₂Al₃O₆FGd₃Ga₅O₁₂:Cr³⁺,Ce³⁺ and graphene quantum dot.

12. The composition according to claim 1, further comprising at least one ingredient selected from the group consisting of an adjuvant, a dispersant, a surfactant, a fungicide, a pesticide, a fertilizer and an antimicrobial agent.

13. A method for manufacturing the composition according to claim 1, comprising adding at least one phosphor into a base composition, wherein
the base composition comprises at least one solvent,
the solvent comprises at least one selected from the group of water and organic solvent, and
preferably the organic solvent comprises at least one selected from the group of alcohol solvent and ether solvent;
wherein optionally the base composition is at least one selected from the group consisting of a pesticide formulation and a fertilizer formulation.

14. (canceled)

15. A container comprising the composition according to claim 1.

16. A method comprising applying the composition according to claim 1 to at least one portion of a plant, wherein
the composition comprises at least one phosphor, and
the phosphor has a peak emission light wavelength less than 500 nm or more than 600 nm,
wherein
optionally the composition is applied to the surface of a single or a plurality of leaves of the plant; or
optionally the composition is applied to a single or a plurality of stems of the plant: or
optionally the average amount of the composition to be applied to the surface of the plant leaves is 0.0005-0.1 mL/cm² of the surface; or
optionally the composition is applied to the surface of the plant by spraying, watering, dropping, dipping, coating or combination of thereof; or
optionally the composition is applied one or more times during the growing season of the plant.

17-18. (canceled)

19. A method for producing or controlling a condition of one or more plants, preferably controlling a photosynthesis of one or more plants, by applying method according to claim 16.

20-22. (canceled)

23. A plant coated by at least one species of phosphor, wherein the phosphor has a peak emission light wavelength less than 500 nm or more than 600 nm;
wherein optionally the phosphor emit light has a peak wavelength in the range of 400-500 nm or 600-750 nm; or
optionally the total amount of the phosphor on the plant is in the range of 0.000001-0.001 g/cm², preferably 0.00001-0.0001 g/cm², more preferably 0.00003-0.00008 g/cm².

24. (canceled)

25. The plant according to claim 23, wherein the phosphor comprises a first phosphor, a second phosphor and/or a third phosphor,
the first phosphor has at least a first peak wavelength of light emitted from the phosphor in the range of 600-750 nm, preferably it is 650-720 nm, more preferably it is 660-710 nm,
the second phosphor has at least a first peak wavelength of light emitted from the phosphor in the range of 400-500 nm, preferably it is 400-490 nm, more preferably it is 430-480 nm, and
the third phosphor has a first peak wavelength of light emitted from the phosphor in the range of 600-750 nm and a second peak wavelength of light emitted from the phosphor of 400-500 nm, preferably the first peak wavelength is in the range of 650-720 nm, and the second peak wavelength is in the range of 400-490 nm, more preferably the first peak wavelength is in the range of 660-710 nm and the second peak wavelength is in the range of 430-480 nm.

26. (canceled)

27. A container comprising the plant according to claim 23.

28. A method for agricultural purposes, including improvement of controlling property of plant condition, preferably controlling of a plant height; controlling of color of fruits; promotion and inhibition of germination; controlling of synthesis of chlorophyll and carotenoids preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites (polyphenols, anthocyanins); controlling of a disease resistance of plants; controlling of ripening of fruits, or controlling of weight of plant, comprising applying a composition according to claim 1.

29-30. (canceled)
